(19) United States
(12) Patent Application Publication
(10) Pub. No.: US 2024/0242593 A1
(43) Pub. Date: Jul. 18, 2024

(54) VEHICLE MONITORING APPARATUS AND VEHICLE MONITORING METHOD

(71) Applicant: Panasonic Intellectual Property Management Co., Ltd., Osaka (JP)

(72) Inventor: Hidetoshi YAMAZAKI, Kanagawa (JP)

(73) Assignee: Panasonic Intellectual Property Management Co., Ltd., Osaka (JP)

(21) Appl. No.: 18/408,295

(22) Filed: Jan. 9, 2024

(30) Foreign Application Priority Data
Jan. 16, 2023 (JP) 2023-004595

(51) Int. Cl. G08B 25/00; G01C 21/36; G07C 5/00; G08B 21/02; G08B 21/18; G08B 25/10; H04W 4/44

(52) U.S. Cl. CPC G08B 25/001; G01C 21/3697; G07C 5/008; G08B 21/02; G08B 21/182; G08B 25/10; H04W 4/44

(57) ABSTRACT

A vehicle monitoring server communicates with a vehicle to acquire information related to a traveling condition of the vehicle. The vehicle monitoring server detects an area outside a communication range where communication with the vehicle is unavailable. The vehicle monitoring server calculates an expected stay time for which the vehicle remains in the area outside the communication range. The vehicle monitoring server executes a safety confirmation process in a mode, of a plurality of modes of safety confirmation process characterized by different loads, corresponding to a traveling condition of the vehicle acquired so far, when a time elapsed since communication with the vehicle became unavailable exceeds the expected stay time.

### BACKGROUND

### 1. Field

The present disclosure relates to data processing technologies and, in particular, to vehicle monitoring apparatus and vehicle monitoring methods.

### 2. Description of the Related Art

A technology is proposed whereby a server calculates an expected stay time for which a vehicle remains in an area outside a communication range, based on information on the area outside the communication range and traveling route information communicated from the vehicle, and executes a safety confirmation process when communication with the vehicle is not resumed beyond the expected stay time (see, for example, Patent Literature 1).
[Patent literature 1] WO2019/198366

The server of patent literature 1 uniformly performs safety confirmation when communication with the vehicle is not resumed beyond the expected stay time. Therefore, safety confirmation that is otherwise unnecessary may be performed, and the load on the server may increase.

### SUMMARY

The present disclosure addresses the issue, and a purpose thereof is to provide a technology for efficiently confirming safety related to a vehicle traveling in area outside the communication range.

A vehicle monitoring apparatus according to an embodiment of the present disclosure includes: an acquisition unit that communicates with a vehicle to acquire information related to a traveling condition of the vehicle; a detection unit that detects an area outside a communication range where communication with the vehicle is unavailable; a calculation unit that calculates an expected stay time for which the vehicle remains in the area outside the communication range; and a safety confirmation unit that executes a safety confirmation process in a mode, of a plurality of modes of safety confirmation process characterized by different loads, corresponding to a traveling condition of the vehicle acquired so far, when a time elapsed since communication with the vehicle became unavailable exceeds the expected stay time.

Another embodiment of the present disclosure relates to a vehicle monitoring method. The method is executed by a computer and includes: communicating with a vehicle to acquire information related to a traveling condition of the vehicle; detecting an area outside a communication range where communication with the vehicle is unavailable; calculating an expected stay time for which the vehicle remains in the area outside the communication range; and executing a safety confirmation process in a mode, of a plurality of modes of safety confirmation process characterized by different loads, corresponding to a traveling condition of the vehicle acquired so far, when a time elapsed since communication with the vehicle became unavailable exceeds the expected stay time.

Optional combinations of the aforementioned constituting elements, and implementations of the present disclosure in the form of systems, computer programs, and recording mediums recording computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the configuration of a communication system of the embodiment;

FIG. 2 is a block diagram showing functional blocks of the vehicle;

FIG. 3 is a block diagram showing functional blocks of the vehicle monitoring server;

FIG. 4 is a sequence chart showing the operation of the communication system;

FIG. 5 is a flowchart showing the operation of the vehicle;

FIG. 6 is a flowchart showing the operation of the vehicle monitoring server; and

FIG. 7 is a flowchart showing the detail of the vehicle monitoring process in the vehicle monitoring server.

### DETAILED DESCRIPTION OF THE EMBODIMENTS

The invention will now be described by reference to the preferred embodiments. This does not intend to limit the scope of the present invention, but to exemplify the invention.

The apparatus or the entity that executes the method according to the disclosure is provided with a computer. By causing the computer to run a program, the function of the apparatus or the entity that executes the method according to the disclosure is realized. The computer is comprised of a processor that operates in accordance with the program as a main hardware feature. The disclosure is non-limiting as to the type of the processor so long as the function is realized by running the program. The processor is comprised of one or a plurality of electronic circuits including a semiconductor integrated circuit (IC) or a large-scale integration (LSI). The terms IC and LSI may change depending on the level of integration, and the processor may be comprised of a system LSI, a Very Large Scale Integration (VLSI), or an Ultra Large Scale Integration (ULSI). A field programmable gate array (FPGA), which is programmed after an LSI is manufactured, or a reconfigurable logic device, in which connections inside the LSI can be reconfigured or circuit compartments inside the LSI can be set up, can be used for the same purpose. The processor may include at least one of a system on a chip (SoC), a micro processor unit (MPU), or a micro controller unit (MCU). The plurality of electronic circuits may be integrated in one chip or provided in a plurality of chips. The plurality of chips may be aggregated in one device or provided in a plurality of devices. The program may be recorded in a computer-readable non-transitory recording medium such as a read only memory (ROM), an optical disk, and a hard disk drive or recorded in a computer-readable transitory storage medium such as a random access memory (RAM). The program may be stored in a recording medium in advance or supplied to a recording medium or a recording medium via wide area communication network including the Internet.

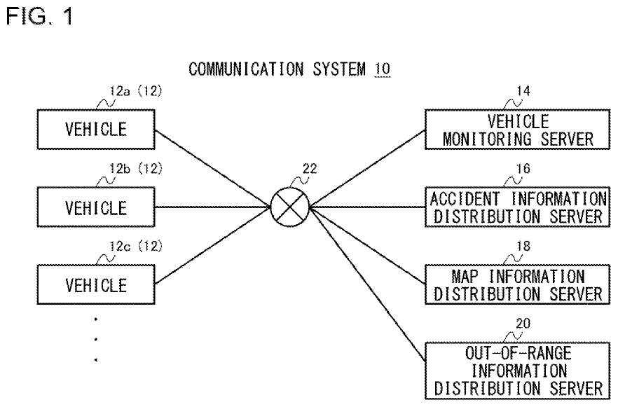

FIG. 1 shows the configuration of a communication system 10 of the embodiment. The communication system 10 includes a plurality of vehicles 12, a vehicle monitoring server 14, an accident information distribution server 16, a map information distribution server 18, and an out-of-range information distribution server 20. These apparatuses are connected via a communication network 22 including LAN, WAN, Internet, etc.

The plurality of vehicles 12 are so-called connected cars and are vehicles to be monitored by the vehicle monitoring server 14. The plurality of vehicles 12 include a vehicle 12a, a vehicle 12b, and a vehicle 12c driven by mutually different users.

The vehicle monitoring server 14 is an information processing apparatus that detects a possibility that an abnormality has occurred in the vehicle 12 or its driver in an area where communication with the vehicle 12 is unavailable (hereinafter also referred to as “an area outside the communication range”) and executes a safety confirmation process. The area outside the communication range of the embodiment is an area where communication using the wireless communication system (e.g., the 4th generation mobile communication system or the 5th generation mobile communication system) is not available.

The accident information distribution server 16 is an information processing apparatus that distributes accident information provided by a police organization, an administrative organization, etc. to an external apparatus. Accident information is typically information related to a traffic accident and includes the date and time of the accident, place where the accident occurred, the type of accident (head-on collision, distracted driving, etc.), and result of the accident (death, serious injury, minor injury, or without injury, etc.).

The map information distribution server 18 is an information processing apparatus that distributes map information provided by a map production company, etc. to an external apparatus.

The out-of-range information distribution server 20 is an information processing apparatus that distributes out-of-range information provided by the mobile network operator to an external apparatus. For example, the out-of-range information includes information indicating the range and position of the area outside the communication area on the map.

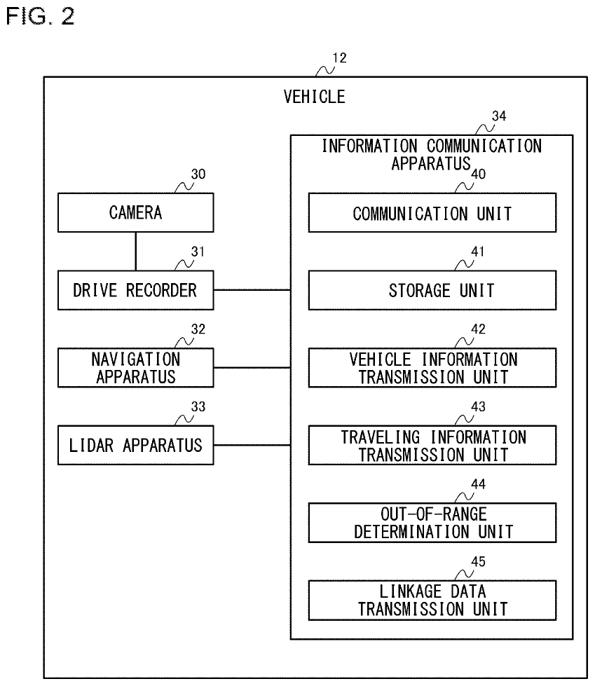

FIG. 2 is a block diagram showing functional blocks of the vehicle 12. FIG. 2 shows the functional blocks of the vehicle 12 related to vehicle monitoring by the vehicle monitoring server 14. The blocks shown in the block diagrams of the present disclosure are implemented in hardware such as devices and mechanical apparatus exemplified by a CPU and a memory of a computer, and in software such as a computer program. FIG. 1 depicts functional blocks implemented by the cooperation of those. It will be understood by those skilled in the art that these functional blocks are implemented in a variety of manners by a combination of hardware and software.

The vehicle 12 includes a camera 30, a drive recorder 31, a navigation apparatus 32, a lidar apparatus 33, and an information communication apparatus 34. The camera 30 is an imaging apparatus that captures an image of the scene around the vehicle 12. The drive recorder 31 stores the video captured by the camera 30. Further, the drive recorder 31 acquires the current speed and average speed of the vehicle 12 and stores the current speed and average speed of the vehicle 12 along with the video captured by the camera 30.

The navigation apparatus 32 provides a car navigation service that provides the current position of the vehicle 12 and route guidance to the destination. The navigation apparatus 32 detects the current position (latitude, longitude, etc.) of the vehicle 12 using a known method such as GNSS (Global Navigation Satellite System).

The lidar apparatus 33 measures the distance and the direction from the vehicle 12 to a surrounding object (other vehicle, obstacle, etc.) using laser light.

The information communication apparatus 34 provides various information necessary for vehicle monitoring by the vehicle monitoring server 14 to the vehicle monitoring server 14. The information communication apparatus 34 may be implemented by a TCU (Telematics Control Unit) and an ECU (Electronic Control Unit).

The information communication apparatus 34 includes a communication unit 40, a storage unit 41, a vehicle information transmission unit 42, a traveling information transmission unit 43, an out-of-range determination unit 44, and a linkage data transmission unit 45. The functions of the vehicle information transmission unit 42, the traveling information transmission unit 43, the out-of-range determination unit 44, and the linkage data transmission unit 45 may be implemented in a computer program. The processor of the information communication apparatus 34 may exhibit the functions of the plurality of functional blocks by reading the computer program into the main memory and executing it.

The communication unit 40 communicates with the external apparatus according to a predetermined communication protocol. In the embodiment, the communication unit 40 communicates with at least the vehicle monitoring server 14 via the communication network 22. The storage unit 41 stores various data. In the embodiment, the storage unit 41 stores at least the identification information on the vehicle 12. The identification information on the vehicle 12 includes a VIN (Vehicle Identification Number) and a serial number. Further, the storage unit 41 stores contact information such as the owner and the driver of the vehicle 12 and their family members. The contact information in the embodiment is a telephone number.

The vehicle information transmission unit 42 transmits vehicle information indicating attributes related to the vehicle 12 to the vehicle monitoring server 14. The vehicle information includes the VIN, the serial number, and the phone number. Further, the vehicle information transmission unit 42 transmits vehicle power supply information indicating the power supply state of the vehicle 12 to the vehicle monitoring server 14. The vehicle power supply information includes information indicating that the vehicle 12 is switched from a power-off state to a power-on state.

The traveling information transmission unit 43 transmits traveling information related to the traveling condition of the vehicle 12 to the vehicle monitoring server 14. The traveling information includes the VIN, serial number, vehicle power supply status, current speed, average speed, current position (e.g., latitude and longitude). The traveling information transmission unit 43 may acquire information on the current speed and average speed from the drive recorder 31. Further, the traveling information transmission unit 43 may acquire the information on the current position from the navigation apparatus 32.

The traveling information transmission unit 43 acquires route information related to the traveling route of the vehicle 12 from the navigation apparatus 32 when the navigation apparatus 32 sets the traveling route of the vehicle 12 according to the destination entered by the user. The traveling route of the vehicle 12 is a route that the vehicle 12 will travel in the future and can be said to be a planned traveling route or a recommended traveling route. The traveling information transmission unit 43 transmits the traveling route information to the vehicle monitoring server 14. The traveling route information includes the VIN, serial number, place of departure, destination, and route information.

The out-of-range determination unit 44 acquires the out-of-range information provided by the mobile network operator from the vehicle monitoring server 14. In one variation, the out-of-range determination unit 44 may acquire the out-of-range information from the out-of-range information distribution server 20. The out-of-range determination unit 44 estimates the time that remains until the vehicle 12 enters the area outside the communication range, based on the position of the area outside the communication area indicated by the out-of-range information, current position of the vehicle 12 acquired from the navigation apparatus 32, and current speed of the vehicle 12 acquired from the drive recorder 31.

The linkage data transmission unit 45 transmits linkage data that serves as a monitoring trigger for vehicle monitoring to the vehicle monitoring server 14 before the vehicle 12 enters the area outside the communication range. In the embodiment, the linkage data transmission unit 45 transmits the linkage data to the vehicle monitoring server 14 when the time that remains until the vehicle 12 enters the area outside the communication range estimated by the out-of-range determination unit 44 becomes less than a predetermined threshold value. The linkage data includes the VIN, serial number, drive recorder image, current position of vehicle 12, lidar information, and information on the number of vehicles around.

The drive recorder image is an image captured by the camera 30 and saved in the drive recorder 31 and is an image capturing the scene around the vehicle 12. The lidar information is information indicating a result of measurement by the lidar apparatus 33 and is, for example, information indicating the distance and direction from the vehicle 12 to each surrounding object. The information on the number of vehicles around is information indicating the number of other vehicles around the vehicle 12. The information communication apparatus 34 may estimate the number of other surrounding vehicles based on the drive recorder image and lidar information using a known method.

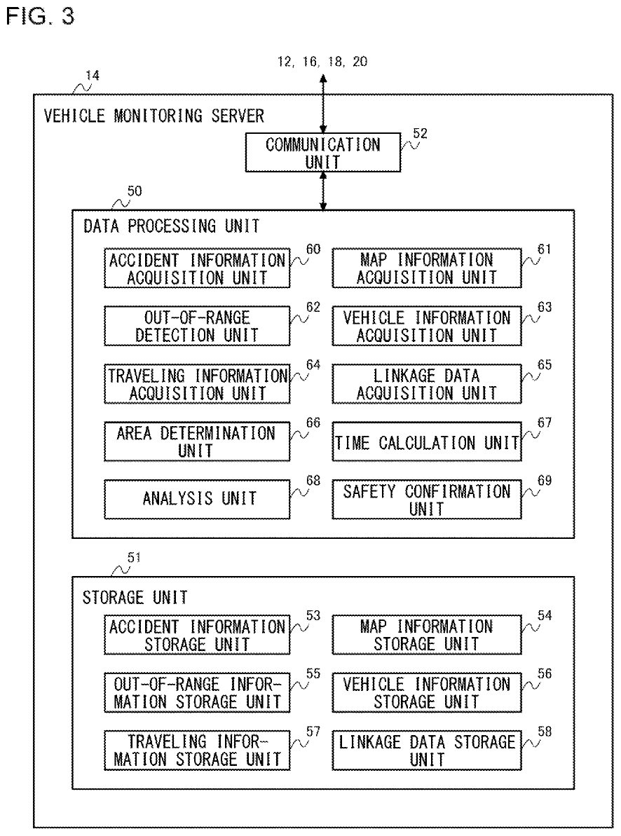

FIG. 3 is a block diagram showing functional blocks of the vehicle monitoring server 14. The vehicle monitoring server 14 includes a data processing unit 50, a storage unit 51, and a communication unit 52. The data processing unit 50 executes a data process related to vehicle monitoring. The storage unit 51 stores data referenced or updated by the data processing unit 50. The communication unit 52 communicates with the external apparatus according to a predetermined communication protocol. The data processing unit 50 transmits/receives data to and from the vehicle 12, the accident information distribution server 16, the map information distribution server 18, and the out-of-range information distribution server 20 via the communication unit 52.

The storage unit 51 is implemented by a memory or a storage. The storage unit 51 includes an accident information storage unit 53, a map information storage unit 54, an out-of-range information storage unit 55, a vehicle information storage unit 56, a traveling information storage unit 57, and a linkage data storage unit 58.

The accident information storage unit 53 stores the accident information distributed from the accident information distribution server 16. The map information storage unit 54 stores the map information distributed from the map information distribution server 18. The out-of-range information storage unit 55 stores the out-of-range information distributed from the out-of-range information distribution server 20. The vehicle information storage unit 56 stores the vehicle information and the vehicle power supply information transmitted from the vehicle 12. The traveling information storage unit 57 stores the traveling information and the traveling route information transmitted from the vehicle 12. The linkage data storage unit 58 stores the linkage data transmitted from the vehicle 12.

The data processing unit 50 includes an accident information acquisition unit 60, a map information acquisition unit 61, an out-of-range detection unit 62, a vehicle information acquisition unit 63, a traveling information acquisition unit 64, a linkage data acquisition unit 65, an area determination unit 66, a time calculation unit 67, an analysis unit 68, and a safety confirmation unit 69. The functions of at least some of the plurality of functional blocks may be implemented in a computer program (hereinafter referred to as “a vehicle monitoring program”). The vehicle monitoring program may be installed in the storage of the vehicle monitoring server 14 via a recording medium or a network. The processor (e.g., CPU) of the vehicle monitoring server 14 may exhibit the functions of the plurality of functional blocks by reading the vehicle monitoring program into the main memory and executing the program.

The accident information acquisition unit 60 acquires the accident information distributed from the accident information distribution server 16 and stores it in the accident information storage unit 53. The map information acquisition unit 61 acquires the map information distributed from the map information distribution server 18 and stores it in the map information storage unit 54. The out-of-range detection unit 62 acquires the out-of-range information distributed from the out-of-range information distribution server 20 and stores it in the out-of-range information storage unit 55. The out-of-range detection unit 62 of the embodiment uses the out-of-range information to detect the position or range of the area outside the communication range where communication with the vehicle 12 is unavailable.

The vehicle information acquisition unit 63 communicates with the vehicle 12 to acquire the vehicle information and vehicle power supply information transmitted from the vehicle 12 and stores these items of information in the vehicle information storage unit 56. The traveling information acquisition unit 64 communicates with the vehicle 12 to acquire the traveling information and traveling route information related to the traveling condition of the vehicle 12 transmitted from the vehicle 12 and stores these items of information in the traveling information storage unit 57. The linkage data acquisition unit 65 communicates with the vehicle 12 to acquire the linkage data transmitted from the vehicle 12 and store it in the linkage data storage unit 58. The area determination unit 66 estimates the danger level of the area (traveling area) where the vehicle 12 travels based the (1) accident information, (2) map information, (3) linkage data, and current position of the vehicle 12 indicated by the linkage data and the traveling information. The area determination unit 66 may estimate that the greater the number of times or frequency of accidents occurring in the traveling area of the vehicle 12, the higher the danger level in the traveling area. In the embodiment, the area is classified into a danger area, a warning area, a standard area, and a safety area in the descending order of danger level. The area determination unit 66 determines whether the traveling area of the vehicle 12 corresponds to any of these four areas.

The time calculation unit 67 calculates the time expected stay time for which the vehicle 12 remains in the area outside a communication range, based on the (1) current position, current speed, and average speed of the vehicle 12 indicated by the traveling information, and (2) position or range of the area outside the communication range detected by the out-of-range detection unit 62.

The analysis unit 68 derives the number of other vehicles located around the vehicle 12 (number of vehicles around) based on the (1) number of vehicles around indicated by the linkage data and (2) drive recorder image and lidar information included in the linkage data. The analysis unit 68 may derive the number of vehicles around by analyzing the drive recorder image and lidar information by a known method. The analysis unit 68 may adopt the number of vehicles around estimated by the vehicle 12 and indicated by the linkage data when the number of vehicles around cannot be derived from the drive recorder image and lidar information.

When the safety confirmation unit 69 receives the linkage data from the vehicle 12, the safety confirmation unit 69 derives the time elapsed since communication with the vehicle 12 (hereinafter also referred to as “a monitored vehicle”) became unavailable. The safety confirmation unit 69 starts determining whether the time elapsed since communication with the monitored vehicle became unavailable exceeds the expected stay time calculated by the time calculation unit 67 in response to the reception of the linkage data. When the time elapsed since communication with the monitored vehicle became unavailable exceeds the expected stay time, the safety confirmation unit 69 executes a safety confirmation process in a mode, of a plurality of modes of safety confirmation processes characterized by different system loads, corresponding to the traveling condition of the monitored vehicle indicated by the traveling information acquired so far.

The safety confirmation process is a process to confirm whether the monitored vehicle or its occupant (driver, etc.) is safe. For example, the safety confirmation unit 69 may, as a safety confirmation process, originate a telephone call destined to the telephone number of the monitored vehicle or its occupant (driver, etc.) communicated in the vehicle information. The safety confirmation unit 69 may determine that the monitored vehicle or its occupant is safe when the telephone call is answered and a specific user operation is entered (such as an input of a specific number). When the safety of the monitored vehicle or its occupant cannot be confirmed, the safety confirmation unit 69 may notify an external apparatus (e.g., an apparatus at a police or administrative agency) that an abnormality has occurred in the monitored vehicle or its occupant.

In the embodiment, the safety confirmation unit 69 executes the safety confirmation process when the time elapsed since communication with the monitored vehicle became unavailable exceeds a standby time equal to or longer than the expected stay time. The lower the danger level of the monitored vehicle based on the traveling condition of the monitored vehicle, the longer the standby time set by the safety confirmation unit 69. In other words, the safety confirmation unit 69 sets a relatively long standby time when the danger level of the monitored vehicle is relatively low and sets a relatively short standby time when the danger level of the monitored vehicle is relatively high. In the embodiment, the standby time is set to a duration (1) equal to the expected stay time, (2) twice the expected stay time, and (3) four times the expected stay time. The longer the standby time, the greater the possibility of resumption of communication, and conversely, the less likely that the safety confirmation process is necessary. According to this aspect, the system load (in other words, resource usage) in the vehicle monitoring server 14 can be suppressed.

The safety confirmation unit 69 determines the danger level of the monitored vehicle based on at least one of the accident occurrence situation in the traveling area of the monitored vehicle or the number of other vehicles traveling around the monitored vehicle. In the embodiment, the safety confirmation unit 69 uses, as the accident occurrence situation in the traveling area of the monitored vehicle, the type of traveling area (danger area, warning area, standard area, safety area) of the monitored vehicle determined by the area determination unit 66 based on the accident occurrence situation. Further, the safety confirmation unit 69 uses, as the number of other vehicles traveling around the monitored vehicle, the number of vehicles around the monitored vehicle derived by the analysis unit 68.

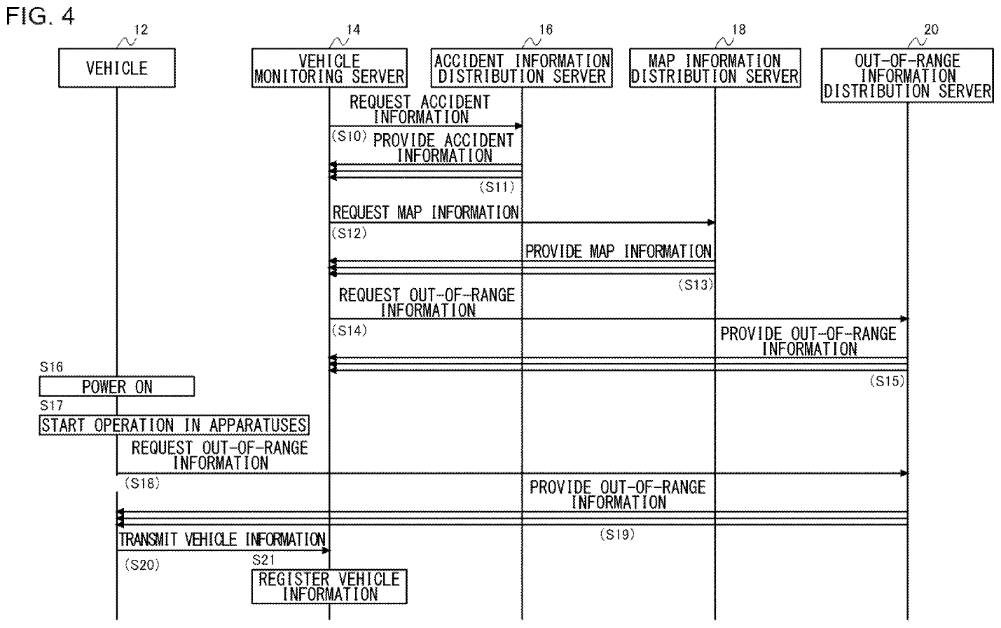

The operation of the communication system 10 according to the above configuration will be described. FIG. 4 is a sequence chart showing the operation of the communication system 10. Although FIG. 4 shows one vehicle 12. In reality, processes related to the plurality of vehicles 12 shown in FIG. 1 are executed in parallel.

The accident information acquisition unit 60 of the vehicle monitoring server 14 requests the accident information distribution server 16 to provide accident information (S10). In response to the request, the accident information distribution server 16 transmits the accident information to the vehicle monitoring server 14 (S11). The accident information distribution server 16 transmits updated accident information data to the vehicle monitoring server 14 each time the accident information is updated.

The map information acquisition unit 61 of the vehicle monitoring server 14 requests the map information distribution server 18 to provide map information (S12). In response to the request, the map information distribution server 18 transmits the map information to the vehicle monitoring server 14 (S13). The map information distribution server 18 transmits updated map information data to the vehicle monitoring server 14 each time the map information is updated.

The out-of-range detection unit 62 of the vehicle monitoring server 14 requests the out-of-range information distribution server 20 to provide out-of-range information (S14). In response to the request, the out-of-range information distribution server 20 transmits the out-of-range information to the vehicle monitoring server 14 (S15). The out-of-range information distribution server 20 transmits updated the out-of-range information data to the vehicle monitoring server 14 each time the out-of-range information is updated.

When the driver of the vehicle 12 switches the power supply state of the vehicle 12 from off to on (S16), each apparatus (drive recorder 31, information communication apparatus 34, etc.) in the vehicle 12 starts operating (S17). The out-of-range determination unit 44 of the information communication apparatus 34 requests the out-of-range information distribution server 20 to provide out-of-range information (S18). In response to the request, the out-of-range information distribution server 20 transmits the out-of-range information to the vehicle 12 (S19). The out-of-range information distribution server 20 transmits updated out-of-range information data to the vehicle 12 each time the out-of-range information is updated.

The vehicle information transmission unit 42 of the information communication apparatus 34 transmits vehicle power supply information and vehicle information to the vehicle monitoring server 14 (S20). The vehicle information acquisition unit 63 of the vehicle monitoring server 14 receives the vehicle power supply information and the vehicle information transmitted from the vehicle 12 and registers them in the vehicle information storage unit 56 (S21).

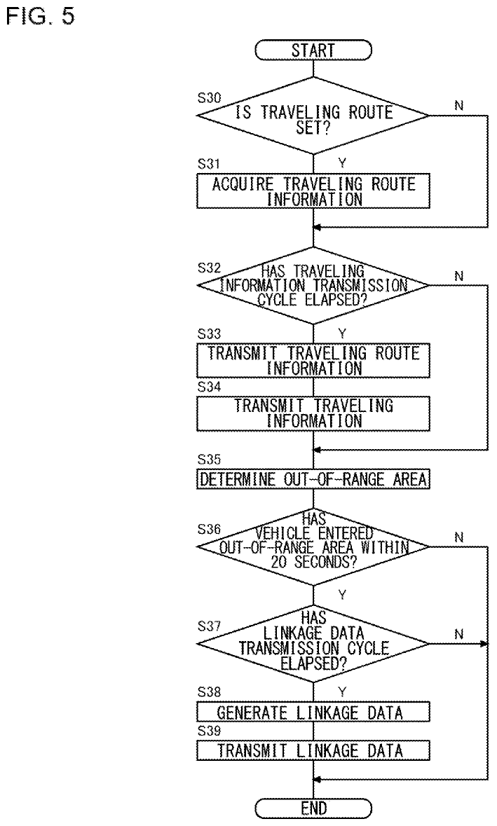

FIG. 5 is a flowchart showing the operation of the vehicle 12. FIG. 5 shows a continuation from the operation of the vehicle 12 shown in FIG. 4. The vehicle 12 repeatedly executes the process shown in FIG. 5.

When the traveling route of the vehicle 12 is set in the navigation apparatus 32 according to the user operation of the driver of the vehicle 12 (Y in S30), the traveling information acquisition unit 64 of the information and communication apparatus 34 acquires traveling route information from the navigation apparatus 32 (S31). When the traveling route of the vehicle 12 is not set (N in S30), the process of S31 is skipped.

Each time a predetermined traveling information transmission cycle (e.g., 10 minutes) elapses (Y in S32), the traveling information acquisition unit 64 of the information communication apparatus 34 transmits the latest traveling route information and traveling information on the vehicle 12 to the vehicle monitoring server 14 (S33, S34). When the traveling information transmission cycle has not elapsed (N in S32), the processes of S33 and S34 are skipped.

The out-of-range determination unit 44 of the information communication apparatus 34 calculates the time that remains until the vehicle 12 enters the area outside the communication range (S35). When the time that remains until the vehicle enters the area outside the communication range is 20 seconds or less (Y in S36), the linkage data transmission unit 45 of the information communication apparatus 34 generates new linkage data and transmits the new linkage data to the vehicle monitoring server 14 (S38, S39) each time a predetermined linkage data transmission cycle (e.g., 1 second) elapses (Y in S37). When the linkage data transmission cycle has not elapsed (N in S37), the processes of S38 and S39 are skipped. When the time that remains until the vehicle enters the area outside the communication range is longer than 20 seconds (N in S36), the processes after S37 are skipped. It should be noted that 20 seconds is a guide. In reality, the value should be determined by taking into account the processing performance of the vehicle 12, communication environment, etc. so that a timer value other than 20 seconds may be used.

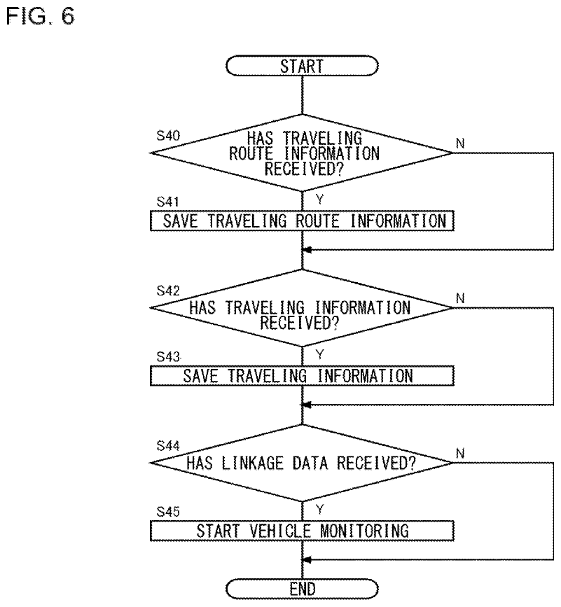

FIG. 6 is a flowchart showing the operation of the vehicle monitoring server 14. FIG. 6 shows a continuation from the operation of the vehicle monitoring server 14 shown in FIG. 4.

When the traveling information acquisition unit 64 of the vehicle monitoring server 14 receives the traveling route information transmitted from the vehicle 12 (Y in S40), the traveling information acquisition unit 64 stores the traveling route information in the traveling information storage unit 57 (S41). When the traveling route information is not received yet (N in S40), the process of S41 is skipped. Further, when the traveling information acquisition unit 64 receives the traveling information transmitted from the vehicle 12 (Y in S42), the traveling information acquisition unit 64 stores the traveling information in the traveling information storage unit 57 (S43). When the traveling information is not received yet (N in S42), the process of S43 is skipped.

When the linkage data acquisition unit 65 of the vehicle monitoring server 14 receives the linkage data transmitted from the vehicle 12 (Y in S44), the linkage data acquisition unit 65 stores the linkage data in the linkage data storage unit 58 and starts the vehicle monitoring process in the vehicle monitoring server 14 (S45). When the linkage data has not been received (N in S44), the process of S45 is skipped.

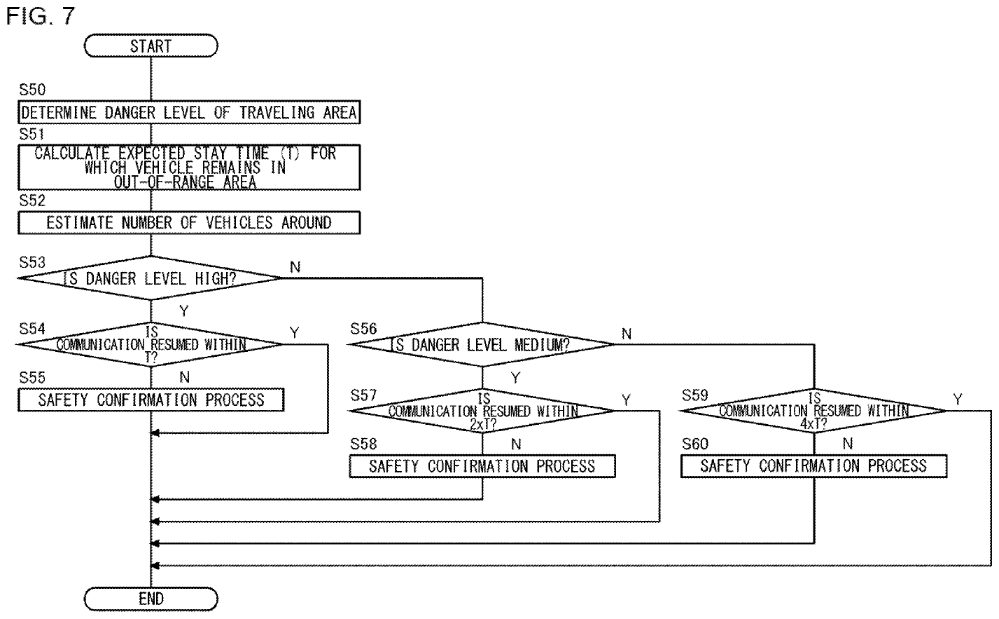

FIG. 7 is a flowchart showing the detail of the vehicle monitoring process in the vehicle monitoring server 14 and shows the detail of the process shown in S45. The area determination unit 66 of the vehicle monitoring server 14 determines the danger level of the traveling area of the vehicle 12 (hereinafter also referred to as “a monitored vehicle”) originating the linkage data (S50). Specifically, the area determination unit 66 determines whether the traveling area of the monitored vehicle is a danger area, warning area, standard area, or safe area. The time calculation unit 67 of the vehicle monitoring server 14 calculates the expected stay time for which the monitored vehicle remains in the area outside the communication range (S51). The analysis unit 68 of the vehicle monitoring server 14 estimates the number of other vehicles traveling around the monitored vehicle (number of vehicles around) (S52).

The safety confirmation unit 69 of the vehicle monitoring server 14 determines the danger level of the monitored vehicle based on the danger level of the traveling area of the monitored vehicle determined in S50 and the number of vehicles around the monitored vehicle determined in S52. In the embodiment, the danger level is defined in three stages including high, medium, and low, but is not limited thereto. The danger level may be defined in two stages or four or more stages.

Further, the safety confirmation unit 69 classifies the number of vehicles around into either excessive, large, medium, a few, or none using predetermined threshold values. For example, “a few” may be one or two, “medium” may be three or four, “many” may be five or six, and “excessive” may be seven or more.

The safety confirmation unit 69 determines that the danger level of the monitored vehicle is high when (case 1) the traveling area of the monitored vehicle is a danger area and the number of vehicles around is “small” or more. The safety confirmation unit 69 also determines that the danger level of the monitored vehicle is high when the driving area of the monitored vehicle is a warning area and the number of vehicles around is “medium” or more.

The safety confirmation unit 69 determines that the danger level of the monitored vehicle is medium when (case 3) the traveling area of the monitored vehicle is a standard area and the number of vehicles around is “large” or more. The safety confirmation unit 69 also determines that the danger level of the monitored vehicle is medium when the driving area of the monitored vehicle is a safe area and the number of vehicles around is “excessive” or more. When none of (case 1)-(case 4) is applicable, the danger level of the monitored vehicle is determined to be low.

When the danger level of the monitored vehicle is high (Y in S53), the safety confirmation unit 69 defines the expected stay time calculated in S51 to be the standby time and confirms whether communication with the vehicle 12 is resumed within the standby time. In the embodiment, the safety confirmation unit 69 determines that communication with the vehicle 12 is resumed when new traveling information is received from the monitored vehicle. When communication with the vehicle 12 is not resumed within the standby time (N in S54), the safety confirmation unit 69 executes a safety confirmation process such as a telephone call to the owner of the monitored vehicle or his or her family (S55). When communication with the vehicle 12 is resumed within the standby time (Y in S54), the process of S55 is skipped, and the execution of the safety confirmation process is suppressed.

When the danger level of the monitored vehicle is medium (N in S53, Y in S56), the safety confirmation unit 69 defines a standby time twice as long as the expected stay time calculated in S51 and confirms whether communication with the vehicle 12 is resumed within the standby time. When communication with the vehicle 12 is not resumed within the standby time (N in S57), the safety confirmation unit 69 executes the safety confirmation process (S58). When communication with the vehicle 12 is resumed within the standby time (Y in S57), the process of S58 is skipped, and execution of the safety confirmation process is suppressed. Since the standby time may be longer than the duration of high danger, the standby time may not necessarily be fixed to be twice as long but may be 1.2 times or 3 times as long.

When the danger level of the monitored vehicle is low (N in S56), the safety confirmation unit 69 defines a standby time four times the expected stay time calculated in S51 and confirms whether communication with the vehicle 12 is resumed within the standby time. When communication with the vehicle 12 is not resumed within the standby time (N in S59), the safety confirmation unit 69 executes the safety confirmation process (S60). When communication with the vehicle 12 is resumed within the standby time (Y in S59), the process of S60 is skipped, and execution of the safety confirmation process is suppressed. After completing the process shown in FIG. 7, the vehicle monitoring server 14 repeatedly executes the process shown in FIG. Since the standby time may be longer than the duration of high danger or medium danger, the standby time may not necessarily be fixed to be 4 times as long but may be 3 times or 5 times as long.

According to the vehicle monitoring server 14 of the embodiment, a safety confirmation process of a load corresponding to the traveling condition of the monitored vehicle is executed. When the danger level of the traveling condition of the monitored vehicle is low, for example, the frequency of safety confirmation process is reduced. Thereby, the load (in other words, resource usage) of the vehicle monitoring server 14 can be suppressed. Further, the vehicle monitoring server 14 starts monitoring the vehicle 12 in response to the reception of the linkage data from the vehicle 12. Thereby, the load on the vehicle monitoring server 14 can be further suppressed.

Given above is a description based on the embodiment. The embodiment is intended to be illustrative only and it will be understood by those skilled in the art that various modifications to combinations of constituting elements and processes of the embodiment are possible and that such modifications are also within the scope of the present disclosure.

A description will be given of a variation. In vehicle monitoring by the vehicle monitoring server 14, the traveling route information on the vehicle 12 is not essential. In one variation, therefore, the traveling route of the vehicle 12 may not be set in the navigation apparatus 32 of the vehicle 12. Further, the traveling route information may not be transmitted from the vehicle 12 to the vehicle monitoring server 14. This is because the expected stay time for which the vehicle 12 remains in the area outside the communication range can be derived based on the current position of the vehicle 12 included in the linkage data, and current position, current speed, and average speed of the vehicle 12 included in the traveling information. According to the vehicle monitoring server 14 of this variation, the vehicle 12 that has not set a traveling route can also be subject to monitoring.

Another variation will be described. The out-of-range detection unit 62 of the vehicle monitoring server 14 may acquire, from an external apparatus, information provided by a mobile network operator and indicating an area inside the communication range where communication using the wireless communication system (e.g., the 4th generation mobile communication system or the 5th generation mobile communication system) is available. The out-of-range detection unit 62 may extract or detect an area derived from excluding the area inside the communication range from a plurality of areas on a map as the area outside the communication area.

The functions of the plurality of functional blocks provided in the vehicle monitoring server 14 of the above embodiment may be distributed and implemented in a plurality of apparatuses, and the plurality of apparatuses communicating with each other and coordinated as a system may implement the same process as executed by the vehicle monitoring server 14 of the above embodiment.

Any combination of the embodiment and the variation described above will also be useful as an embodiment of the present disclosure. New embodiments created by the combination provide the advantages of embodiment and the variation combined. It will also be understood by skilled persons that the functions that the constituting elements recited in the claims should achieve are implemented either alone or in combination by the constituting elements shown in the embodiment and the variations.

### Additional Note

The description of the embodiment and the variation described above discloses the following technologies.

[Technology 1] A vehicle monitoring apparatus including:
an acquisition unit that communicates with a vehicle to acquire information related to a traveling condition of the vehicle;
a detection unit that detects an area outside a communication range where communication with the vehicle is unavailable;
a calculation unit that calculates an expected stay time for which the vehicle remains in the area outside the communication range; and
a safety confirmation unit that executes a safety confirmation process in a mode, of a plurality of modes of safety confirmation process characterized by different loads, corresponding to a traveling condition of the vehicle acquired so far, when a time elapsed since communication with the vehicle became unavailable exceeds the expected stay time. According to this vehicle monitoring apparatus, a safety confirmation process of a load corresponding to the traveling condition of the monitored vehicle is executed so that the load (in other words, resource usage) in the vehicle monitoring server can be suppressed.

[Technology 2] The vehicle monitoring apparatus according to technology 1,
wherein the safety confirmation unit executes the safety confirmation process when the time elapsed since communication with the vehicle became unavailable exceeds a standby time equal to or longer than the expected stay time, and
wherein, the lower a danger level of the vehicle based on the traveling condition of the vehicle, the longer the standby time set by the safety confirmation unit. According to this vehicle monitoring apparatus, the lower the danger level of the vehicle, the longer the time to wait for resumption of communication and the lower the frequency of execution of the safety confirmation process so that the load in the vehicle monitoring apparatus can be reduced.

[Technology 3] The vehicle monitoring apparatus according to technology 2,
wherein the danger level of the vehicle is determined based on at least one of an accident occurrence situation in an area traveled by the vehicle or the number of other vehicles traveling around the vehicle. According to this vehicle monitoring apparatus, the danger level of the vehicle can be precisely.

[Technology 4] The vehicle monitoring apparatus according to any one of technologies 1 through 3,
wherein the vehicle transmits predetermined information to the vehicle monitoring apparatus before the vehicle enters the area outside the communication range, and
wherein the safety confirmation unit starts determining whether the time elapsed since communication with the vehicle became unavailable exceeds the expected stay time in response to reception of the predetermined information. According to this vehicle monitoring apparatus, the vehicle monitoring apparatus starts monitoring the vehicle in response to reception of trigger data from the vehicle so that the load on the vehicle monitoring apparatus can be suppressed.

[Technology 5] A vehicle monitoring method executed by a computer, including:
communicating with a vehicle to acquire information related to a traveling condition of the vehicle;
detecting an area outside a communication range where communication with the vehicle is unavailable;
calculating an expected stay time for which the vehicle remains in the area outside the communication range; and
executing a safety confirmation process in a mode, of a plurality of modes of safety confirmation process characterized by different loads, corresponding to a traveling condition of the vehicle acquired so far, when a time elapsed since communication with the vehicle became unavailable exceeds the expected stay time. According to this vehicle monitoring method, a safety confirmation process of a load corresponding to the traveling condition of the monitored vehicle is executed so that the load (in other words, resource usage) in the computer can be suppressed.

While various embodiments have been described herein above, it is to be appreciated that various changes in form and detail may be made without departing from the spirit and scope of the invention (s) presently or hereafter claimed.

### CROSS-REFERENCE TO RELATED APPLICATION

This application is based upon and claims the benefit of priority from the prior Japanese Patent Application No. 2023-004595, filed on Jan. 16, 2023, the entire contents of which are incorporated herein by reference.

What is claimed is:

1. A vehicle monitoring apparatus comprising:
an acquisition unit that communicates with a vehicle to acquire information related to a traveling condition of the vehicle;
a detection unit that detects an area outside a communication range where communication with the vehicle is unavailable;
a calculation unit that calculates an expected stay time for which the vehicle remains in the area outside the communication range; and
a safety confirmation unit that executes a safety confirmation process in a mode, of a plurality of modes of safety confirmation process characterized by different loads, corresponding to a traveling condition of the vehicle acquired so far, when a time elapsed since communication with the vehicle became unavailable exceeds the expected stay time.

2. The vehicle monitoring apparatus according to claim 1,
wherein the safety confirmation unit executes the safety confirmation process when the time elapsed since communication with the vehicle became unavailable exceeds a standby time equal to or longer than the expected stay time, and
wherein, the lower a danger level of the vehicle based on the traveling condition of the vehicle, the longer the standby time set by the safety confirmation unit.

3. The vehicle monitoring apparatus according to claim 2,
wherein the danger level of the vehicle is determined based on at least one of an accident occurrence situation in an area traveled by the vehicle or the number of other vehicles traveling around the vehicle.

4. The vehicle monitoring apparatus according to claim 1,
wherein the vehicle transmits predetermined information to the vehicle monitoring apparatus before the vehicle enters the area outside the communication range, and
wherein the safety confirmation unit starts determining whether the time elapsed since communication with the vehicle became unavailable exceeds the expected stay time in response to reception of the predetermined information.

5. A vehicle monitoring method executed by a computer, comprising:
communicating with a vehicle to acquire information related to a traveling condition of the vehicle;
detecting an area outside a communication range where communication with the vehicle is unavailable;
calculating an expected stay time for which the vehicle remains in the area outside the communication range; and
executing a safety confirmation process in a mode, of a plurality of modes of safety confirmation process characterized by different loads, corresponding to a traveling condition of the vehicle acquired so far, when a time elapsed since communication with the vehicle became unavailable exceeds the expected stay time.
